(19) United States
(12) Patent Application Publication
(10) Pub. No.: US 2025/0135682 A1
(43) Pub. Date: May 1, 2025

(54) CONCRETE CURING SYSTEMS EMPLOYING DRONES

(71) Applicant: Intellitronx Robotics and Data Analytics Corp., Starke, FL (US)

(72) Inventors: Dan G. Zollinger, Bryan, TX (US); Jeffrey L. Koebrick, St. Augustine, FL (US); Claudio E. Manissero, Starke, FL (US)

(21) Appl. No.: 18/929,590

(22) Filed: Oct. 28, 2024

Related U.S. Application Data
(60) Provisional application No. 63/546,158, filed on Oct. 27, 2023.

(51) Int. Cl. B28B 11/24; B64U 20/00; B64U 101/45

(52) U.S. Cl. CPC B28B 11/245; B28B 11/247; B64U 20/00; B64U 2101/45

(57) ABSTRACT

Automated systems for managing the curing of concrete employ drones that may be employed without contacting a surface of the concrete. The drones may include sensing drones, which may monitor one or more conditions of the concrete as it cures, application drones, which may apply moisture, curing aids, and/or other chemicals to the concrete to control the manner in which the concrete cures, and/or support drones that may carry conduits that extend between a source of moisture, a curing aid, and/or another chemical and an application drone to prevent the conduits from contacting the surface of the concrete. Such a system may also include a central control unit that receives information about the curing concrete and uses that information to manage curing of the concrete, including coordination of the movement and operation of various drones used to manage curing of the concrete.

### CROSS-REFERENCE TO RELATED APPLICATION

A claim for priority to the Oct. 27, 2023 filing date of U.S. Provisional Patent Application No. 63/546,158, titled CONCRETE CURING SYSTEMS EMPLOYING DRONES (“the '158 Provisional Application”) is hereby made. The entire disclosure of the '158 Provisional Application is hereby incorporated herein.

### TECHNICAL FIELD

This disclosure relates generally to apparatuses, systems, and methods for facilitating the curing of concrete and to apparatuses, systems, and methods for monitoring concrete as it cures. More specifically, this disclosure relates to so-called “non-contact” apparatus, systems, and methods for use in connection with concrete curing. Even more specifically, this disclosure relate to apparatuses, systems, and methods that include drones in connection with concrete curing; for example, to apply moisture (e.g., water, etc.) and/or curing agents, to monitor the curing concrete, and the like.

### RELATED ART

The curing of concrete can be a temperamental process. If curing conditions, including the temperature and water content of the concrete, are not correct during the early curing period, or for the first few days (e.g., three days, seven days, etc.) of the curing process, hydration of the concrete (i.e., the reaction between water and cement in the concrete) may be adversely affected, which may prevent the concrete from setting and hardening properly and, thus, negatively affect the durability of the concrete. Atmospheric changes (i.e., changes in the weather) may adversely affect hydration and, thus, the quality of the curing concrete. A variety of so-called failures can result from improper hydration, including cracking, spalling, curling, and loss of strength.

When concrete pavement is placed, evaporation happens at the surface, not uniformly throughout the pavement. When the concrete pavement is not properly hydrated, the surface may shrink laterally while lower, more hydrated portions of the concrete substantially retain or retain their lateral dimensions (e.g., they do not experience significant lateral shrinkage). Such asymmetric shrinkage may result in strain within the concrete pavement. One consequence of such strain may be a concrete pavement with a top that is not fully supported by its bottom, which may cause roughness and concave surfaces in sections of the concrete pavement.

Evaluations of the effectiveness of concrete curing are typically conducted in the laboratory using ASTM C 156 (Water Retention by Concrete Curing Materials). The deficiencies of evaluating concrete curing processes in this manner include: (1) test conditions hold little relevance to field conditions; (2) laboratory measurements are often not useful or transferable to the environments in which concrete is cured; and (3) they provide a questionable basis for moisture loss limits and have limited relevance to the short-term and long-term performance of the concrete.

Conventionally, a variety of techniques have been used to prevent failures from occurring as concrete cures. These include passive controls, such as the use of membranes or curing compounds over the surface of curing concrete, the inclusion of shrinkage additives or concrete reinforcing fibers in the concrete mixture, and saw cutting the concrete. The effectiveness of passive controls is still subject to atmospheric conditions (i.e., the weather) and changes in atmospheric conditions. Moreover, the use of passive controls does not provide information that may be useful in compensating for changes in atmospheric conditions or the effects such changes may have on hydration of the curing concrete.

Active controls have the potential to prevent failures from occurring as concrete cures by providing data during curing that may lead to real-time adjustments to the curing process. One example of an existing active control device is known as a concrete curing maturity meter. The concrete curing maturity meter measures the dry bulb temperature (T) and dew point temperature (Dp) of the concrete, from which relative humidity (RH) is calculated, as well as the temperature (e.g., dry bulb temperature, etc.), relative humidity, wind speed, and solar radiation of the environment in which the curing concrete is located. Dry bulb temperature is the temperature of air as measured by a thermometer that is not affected by moisture or radiation; dry bulb temperature is commonly referred to as “air temperature.” Dew point temperature is the temperature air needs to be cooled to (at constant pressure) to achieve a relative humidity of 100%. With the dry bulb temperature and dew point temperature, relative humidity may be calculated as follows:

$$R H = 100 \times \frac{{e}^{\frac{17.625 \times {D}_{p}}{243.04 + {D}_{p}}}}{{e}^{\frac{17.625 \times T}{243.04 + T}}}$$

The concrete curing maturity meter positions a pair of chilled mirror dew point temperature (DPT) sensors, or chilled mirror hygrometers, within the curing concrete to monitor its dry bulb temperature and dew point temperature. One of the chilled mirror hygrometers measures the dry bulb temperature and dew point temperature slightly below the surface of the curing concrete, while the other chilled mirror hygrometer provides the dry bulb temperature and dew point temperature from deeper within the curing concrete.

In jointed pavements, the joint interval is either designed to provide for each expected crack at 3 m to 5 m (12 to 15 ft) intervals (plain slab design). Studies have shown that pavement thickness, base stiffness, and climate affect the maximum anticipated joint spacing beyond which transverse cracking can be expected (Smith, et al, 1990). Research indicates that there is a general relationship between the ratio of slab length (L) to the radius of relative stiffness ( [symbol] ) and transverse cracking. The radius of relative stiffness is a term defined by Westergaard to quantify the relationship between the stiffness of the foundation and the flexural stiffness of the slab.

Experience indicates that there is an increase in transverse cracking when the ratio L/ [symbol] exceeds 4.44. Using the criterion of a maximum L/ [symbol] ratio of 4.44, the allowable joint spacing would increase with increased slab thickness but decrease with increased (stiffer) foundation support conditions. The relationship between slab length, slab thickness, and foundation support for a L/ [symbol] ratio of 4.44 is shown in FIG. 7. Methods are available to take the effect of the subbase into account in determination of the k-value (Darter et. al. 1995; Hall et. al. 1997).

Current technology for controlling the location and extent of cracking in concrete is too slow to adequately respond to curing and crack control needs over a wide area during paving operations while trying to keep pace with the curing requirements from one location to the next.

### SUMMARY

Apparatuses, systems, and methods that are used in connection with concrete curing employ drones. The drones may be used to facilitate the application of moisture (e.g., water, etc.) and/or curing agents, to facilitate monitoring of curing conditions, and the like.

In one aspect, an autonomous system for managing the curing of concrete includes one or more devices that obtain data relevant to the curing quality of a slab of concrete or another concrete structure. Such devices may include the sampling tubes and monitoring systems described by U.S. patent application Ser. No. 17/722,295, titled MONITORING OF CURING CONCRETE (“the '295 application”) and the dielectric probes and systems described by U.S. patent application Ser. No. 18/929,151, titled MONITORING A DIELECTRIC CONSTANT OF CURING CONCRETE (“the '151 application”). The entire disclosures of the '295 application and the '151 application are hereby incorporated herein. In addition, such a system may include one or more drones positionable over different locations of the concrete slab or other concrete structure without contacting the concrete. Since the drone(s) do(es) not contact the concrete, it/they may be used with concrete that is pliable, or in a plastic state. Such a drone may use ground penetrating radar (GPR) technology sense the curing quality of the concrete and, thus, may be referred to as a “sensing drone.”

In another aspect, an autonomous system for managing the curing of concrete includes at least one drone positionable over different locations of the concrete without contacting the concrete. The at least one drone may include a pump and one or more nozzles that apply moisture, a curing aid (e.g., an evaporation inhibitor), or another chemical (e.g., a finishing aid, a cutting aid, a hardener/densifier, a silane, another protective surface treatment, etc.) to the concrete. Optionally, the drone(s) may also include one or more tanks for storing the moisture, the curing aid, and/or the other chemical. As another option, such an autonomous system may include at least one source of moisture (e.g., water, etc.), a curing aid, and/or other chemicals that may affect the manner in which the concrete cures in proximity to the concrete and at least one conduit including a first end in communication with the at least one source and a second end coupled to the at least one drone. Since such a drone may apply water, curing aids, or other chemicals to the concrete, it may be referred to as an “application drone.”

In embodiments where the autonomous system includes a source of moisture, a curing aid, and/or another chemical, the autonomous system may include a plurality of sources of moisture, curing aids (e.g., different curing aids, etc.), and/or other chemicals. In some embodiments where the autonomous system includes a plurality of sources, a separate application drone may be used with each source. In other embodiments where the autonomous system includes a plurality of sources, a single application drone may be coupled to at least one conduit that selectively communicates with each of the plurality of sources.

An autonomous system may include a variety of different types of drones, including one or more sensing drones and one or more application drones. A sensing drone may employ ground penetrating radar or any other suitable technology to determine the moisture content of the curing concrete at the different locations. An application drone may selectively apply moisture, a curing aid, and/or another chemical to one or more areas of a surface of the curing concrete based on a moisture content and other features of the concrete. A support drone may carry an intermediate portion of a conduit to prevent the conduit from contacting the surface of the concrete. Each drone (e.g., sensing drone, application drone, support drone, etc.) may include a processor. The processor may control operation of the drone and one or more functions of the drone. In circumstances where a drones function together, or in concert, the processor may communicate with a central control unit that coordinates or orchestrates operation of the different drones, including different types of drones, enabling them to work together efficiently and without incident (e.g., without collisions, etc.) to ensure optimal curing of the concrete.

In some embodiments, the autonomous system may also include a plurality of sensors at different locations of the concrete. The sensors may determine a moisture content of the concrete at the different locations. The sensors may communicate data regarding the moisture content to the drone(s) or to the central control unit.

In another aspect, a method for curing concrete includes monitoring a condition of the concrete at different locations. The condition of the concrete may be monitored with equipment (e.g., probes, sampling tubes, etc.) that contact the concrete and/or with one or more drones (e.g., sensing drones) that monitor the concrete without contacting the concrete. The method may also include deploying a drone (e.g., an application drone) above a particular location of the different locations of the concrete based on the monitoring, and, with the drone, applying moisture, a curing aid, and/or another chemical to the particular location of the concrete based on the monitoring. One or more other drones (e.g., one or more support drones) may carry an optional conduit extending between an optional source of the moisture, curing aid, and/or other chemical and the drone that applies the curing aid at an intermediate location.

Monitoring the condition of the concrete may include monitoring a dielectric constant (and a volumetric water content) of the concrete at the different locations, monitoring a humidity of the concrete at the different locations, and/or monitoring a strain of the concrete at the different locations. The condition(s) of the concrete may be monitored with a sensing drone. More specifically, the sensing drone may use ground penetrating radar and/or sensors at different locations in the concrete (e.g., its surface, at least partially within the concrete, etc.) to monitor the condition(s) of the concrete. When a sensing drone is used to monitor the surface of the concrete, the drone may be located over the surface of the concrete without contacting the concrete. In some embodiments, the drone may be located within about 18 inches (about 0.45 m) of the surface of the concrete, within about 12 inches (about 0.30 m) of the surface of the concrete, within about 6 inches (about 0.15 m) of the surface of the concrete, within about 3 inches (about 7.5 cm) of the surface of the concrete, about an inch (about 2.5 cm) above the surface of the concrete, etc. Of course, the drone may also operate farther than 18 inches (0.45 m) from the surface of the concrete.

A processor, such as a processor of an application drone or a processor of a central control unit, may receive the data obtained while monitoring the concrete, identify any issues that have arisen during curing of the concrete, and, if necessary, communicate with one and deploy one or more additional drones (e.g., one or more application drones and, optionally, one or more support drones, etc.) to address any issues that have arisen while the concrete cures.

The application drone(s) and any support drone(s) may apply moisture, a curing compound, and/or another chemical to the concrete to address any issues that have arisen as the concrete cures. The processor may control the manner in which application drone(s) apply the moisture, curing aid, and/or other chemicals to address specific issues that have arisen. The processor may also coordinate movement of various drones to enable them to function in concert with each other.

Other aspects of the disclosed subject matter, as well as features and advantages of various aspects of the disclosed subject matter, should become apparent to those of ordinary skill in the art through consideration of the ensuing description, the accompanying drawings, and the appended claims.

### BRIEF DESCRIPTION OF THE DRAWINGS

In the drawings:

FIG. 1 depicts an embodiment of a sensing drone of this disclosure;

FIG. 2 depicts an embodiment of an application drone of this disclosure;

FIG. 3 depicts an embodiment of a support drone of this disclosure;

FIG. 4 is a schematic representation of an autonomous system for managing the curing of concrete, including monitoring equipment that optionally includes one or more sensing drones of FIG. 1.

FIG. 5 is a schematic representation of an autonomous system for managing the curing of concrete that includes one or more application drones of FIG. 2 and, optionally, one or more support drones of FIG. 3;

FIG. 6 is a schematic representation of an autonomous system for managing the curing of concrete that includes one or more sensing drones of FIG. 1, one or more application drones of FIG. 2, one or more optional support drones of FIG. 3, and a central control unit that controls operation of the sensing drone(s), application drone(s), and optional support drone(s) to orchestrate their movement and operation; and

FIG. 7 is a graph showing the relationship between slab length, slab thickness, and foundation support for a L/ [symbol] ratio of 4.44, a limit above which in transverse cracking of concrete often occurs.

### DETAILED DESCRIPTION

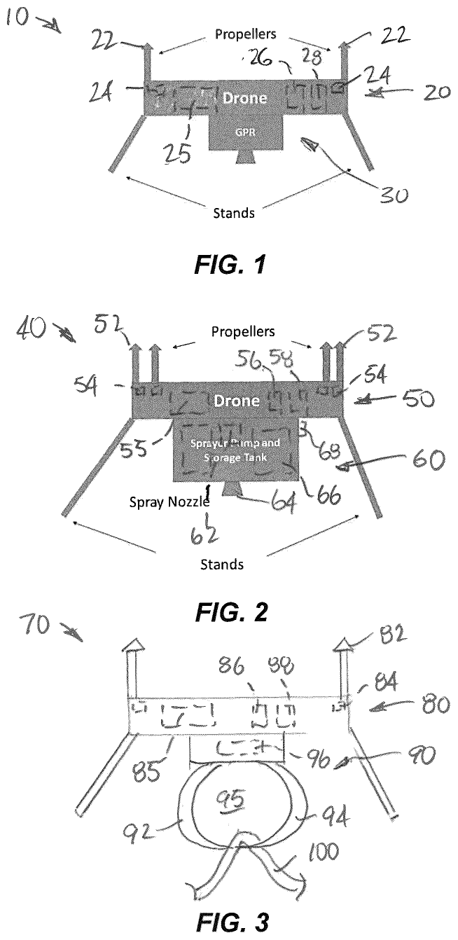

FIG. 1 illustrates an embodiment of a sensing drone 10. The sensing drone 10 comprises a drone 20 and a sensor 30. The drone 20 is capable of flight and, thus, may include propellors 22 driven by one or more motors 24. A battery 25 may supply power to the motor(s) 24. The drone 20 may also include a processor 26 that receives power from the battery 25 and controls operation of the drone 20 and the sensor 30. In addition, the drone 20 includes a radio 28, which may also receive power from the battery 25 and communicate wirelessly with a control unit (not shown) and/or other external devices (not shown).

The sensor 30 of the sensing drone 10 may comprise any type of sensor that may be used to sense a property or a condition of concrete without contacting the concrete. Without limitation, the sensor 30 may comprise ground penetrating radar (GPR). The sensor 30 may receive power from the battery 25. Operation of the sensor 30 may be controlled by the processor 26.

FIG. 2 illustrates an embodiment of an application drone 40. The application drone 40 comprises a drone 50 and a fluid application system 60. Optionally, the application drone 40 includes a fluid coupler 70. The drone 50 is capable of flight and, thus, may include propellors 52 driven by one or more motors 54. A battery 55 may supply power to the motor(s) 54. The drone 50 may also include a processor 56 that receives power from the battery 55 and controls operation of the drone 50 and the fluid application system 60. In addition, the drone 50 includes a radio 58, which may also receive power from the battery 55 and communicate wirelessly with a control unit (not shown) and/or other external devices (not shown).

The fluid application system 60 of the application drone 40 may comprise any type of fluid application system suitable for use in applying a fluid to concrete. For example, the fluid application system 60 may include a pump 62 and one or more nozzles 64. The pump 62, which receives power from the battery 55, may draw fluid from a source, such as a storage tank 66 carried by the drone 50 or a fluid coupler 68 that establishes fluid communication between the drone 50 and an external source of a fluid, such as water, a curing aid, or another chemical. The pump 62 also pressurizes the fluid to force it to and through the nozzle(s) 64. The nozzle(s) 64 may direct the fluid in a predetermined direction, enabling application of the fluid to the surface of curing concrete. Without limitation, the nozzle(s) 64 of the fluid application system 60 may include a plurality of spray nozzles.

The nozzle(s) 64 may spray moisture, a curing aid, and/or another chemical in a designed manner. The nozzle(s) 64 may produce a jet, a spray, drops, or other discharge (e.g., in spray pattern of a cone, etc.). The nozzle(s) 64 may deliver fluid in a pulsating nature (i.e., in successive, separate volumes), in an oscillating fashion, a circular pattern, or the like to enhance uniformity in application and coverage of the applied water, curing aid, or other chemical. A nozzle 64 may comprise a rotary spray nozzle (e.g., a multi-axis rotary spray nozzle adapted for use for curing aids and/or other chemicals, etc.).

As an alternative to an application drone, a spray mounted carriage assembly movable across the surface of the concrete may be used to apply a curing compound to the concrete,

FIG. 3 illustrates an embodiment of a support drone 70. The support drone 70 may include a drone 80 and a conduit carriage 90. The drone 80 is capable of flight and, thus, may include propellors 82 driven by one or more motors 84. A battery 85 may supply power to the motor(s) 84. The drone 80 may also include a processor 86 that receives power from the battery 85 and controls operation of the drone 80 and the conduit carriage 80. In addition, the drone 80 includes a radio 88, which may also receive power from the battery 85 and communicate wirelessly with a control unit (not shown) and/or other external devices (not shown).

The conduit carriage 90 of the support drone 70 may comprise any type of mechanism can grasp and retain a conduit 100, such as a flexible hose. For example, the conduit carriage 90 may comprise claws 92 and 94 that engage a conduit 100 from opposite sides and close around the conduit 100, as well as a motor 96 that closes and opens the claws 92 and 94. When closed around the conduit 100, the claws 92 and 94 may engage the conduit 100 in a manner that securely retains the conduit 100 while enabling it to slide through an enclosed opening 95 defined by the claws 92 and 94.

Optionally, a drone 20, 60, 80 may include a mounting system for affixing one or more sensors (e.g., a GPR, etc.), an application system (e.g., a pump, nozzles, etc.), and/or a conduit-engagement system. Thus, a single type of done may be used for a variety of purposes.

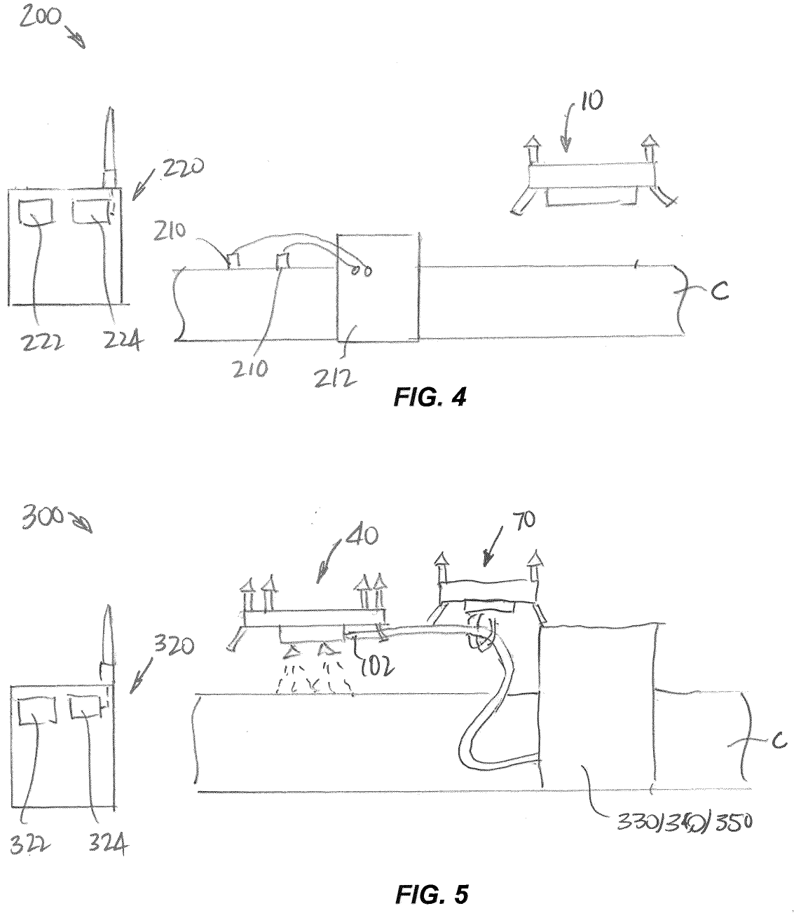

Turning now to FIG. 4, an embodiment of an autonomous system 200 that monitors curing concrete is depicted. The autonomous system 200 includes one or more sensing drones 10, as well as sensors or probes 210 in the concrete C and related equipment 212 (e.g., a base station that operates with the sensors or probes 210, collects environmental data, etc.) on or adjacent to the concrete C. Examples of sensors or probes 210 and related equipment 212 are disclosed by the '295 application and the '151 application.

Optionally, the autonomous system 200 may include a central control unit 220 with a processor 222 that receives data from the sensors or probes 210, the related equipment 212, and/or the sensing drone(s) 10. The processor 222 of the central control unit 220 may control the operation of other components of the autonomous system 200, including the sensing drone(s) 10. The processor 222 may communicate wirelessly with the other components of the autonomous system 200 by way of a radio 224. Operation of the sensing drone(s) 10 may be coordinated with operation of other components of the autonomous system 200, as well as with other devices (e.g., one or more application drones 40 (FIG. 2), one or more support drones 70 (FIG. 3), etc.).

FIG. 5 depicts an embodiment of an autonomous system 300 that affects the manner in which concrete cures. The autonomous system 300 includes one or more application drones 40 and, optionally, one or more support drones 70. The autonomous system 300 may also include one or more sources 330, 340, 350 of fluids that may affect the manner in which concrete cures. For example, source 330 may comprise a source (e.g., a tank, a tote, a barrel, etc.) that contains water. Source 340 may comprise a source (e.g., a tank, a tote, a barrel, etc.) of a curing aid. Source 350 may comprise a source (e.g., a tank, a tote, a barrel, etc.) of another chemical. In addition, the autonomous system 300 may include conduits 100 that communicate fluid from the sources 330, 340, and 350 to the application drone(s). More specifically, each conduit 100 may include an end 102 that couples to the fluid coupler 68 (FIG. 2) of an application drone 40.

Optionally, the autonomous system 300 may include a central control unit 320. The central control unit 320 includes a processor 322 that receives data regarding the condition of the concrete C (e.g., from sensors or probes 210 (FIG. 4) related equipment 212 (FIG. 4), a sensing drone 10 (FIGS. 1 and 4), etc.) and, based on that data, controls the operation of the one or more application drones 40 and the one or more optional support drones 70 to apply moisture, one or more curing aids, and/or one or more other chemicals to the concrete C to affect the manner which the concrete cures (e.g., to address issues that arise as the concrete C cures, to engineer and optimize curing of the concrete C, etc.). The processor 322 may receive the data and communicate with the other components of the autonomous system 300 wirelessly, by way of a radio 324.

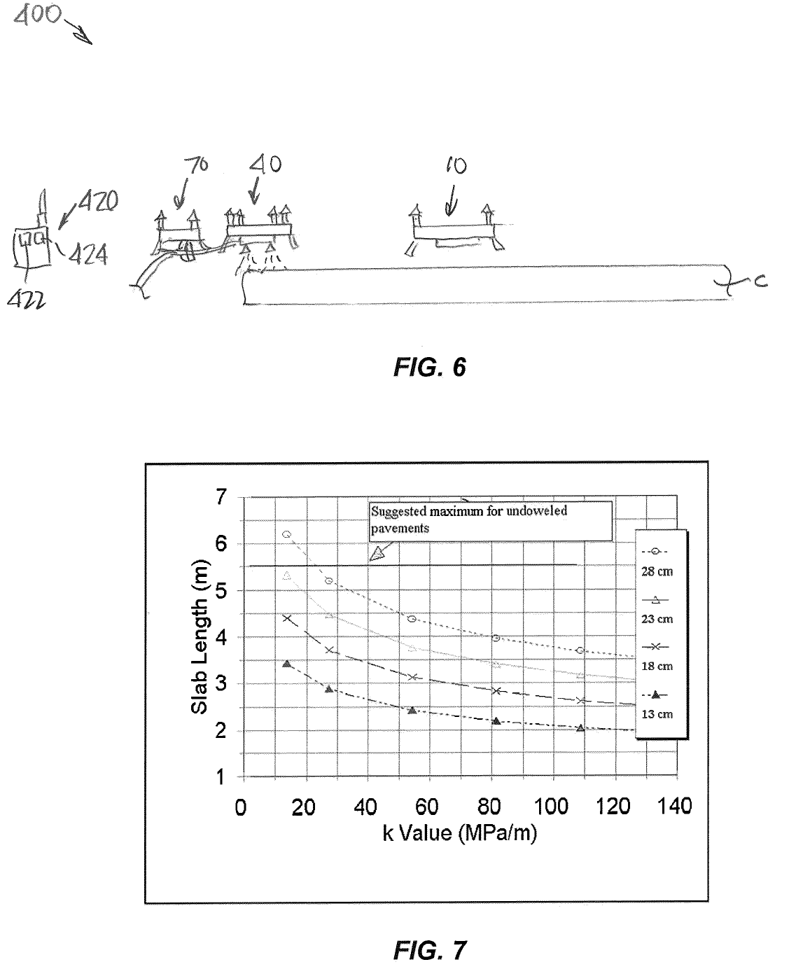

FIG. 6 is a schematic representation of an autonomous system 400 for managing the curing of concrete that includes one or more sensing drones 10, one or more application drones 40, one or more optional support drones 70, and a central control unit 420 that controls operation of the sensing drone(s) 10, application drone(s) 40, and optional support drone(s) 70 to orchestrate their movement and operation. The central control unit 420 may include a processor 422 and a radio 424 that perform the functions of the processors 222 and 322 and the radios 224 and 324 of the autonomous systems 200 and 300 depicted in and described with reference to FIGS. 4 and 5, respectively.

The drones 10, 40, and 70 may be guided by navigation software that tracks the areas covered and enables the drones to travel at predetermined distances above the concrete surface. Operation of the drones 10, 40, and 70 may be coordinated with other autonomous units, such as self-driven power-trowels, saw cutting machines and/or other devices, as well as with manually operated units, such as power-trowels, saw cutting machines, and/or other devices.

An evaluation index (EI) can characterize the effectiveness of any curing system over time for hardening or hardened concrete for laboratory, field, or a standard set of testing conditions. The EI parameter serves as a bridge to field performance by relating concrete surface quality to curing effectiveness and placement conditions. The EI will be instrumental in the real-time management of different application rates and evaporation potentials; providing a means to guide curing practice and adjust on-the-go based on the ambient field conditions and the type of curing system.

Incorporation of integrated autonomous drones in concrete placement operations may be used to monitor cure, as well as control timing for critical curing operations such as the application of moisture, curing aids, and/or other chemicals to curing concrete, as well as the timing of other finishing processes. Non-contact, or contactless, concrete curing application and sensor monitoring devices are powered and positioned over a surface of curing concrete for contactless applications facilitating monitoring and application towards an integrated, responsive, and intelligent delivery system facilitating performance engineered curing (PEC) and finishing of new concrete slabs, pavements, bridge decks, and the like. A system and a method incorporate an integrated platform and drone assisted monitoring and application devices and machinery with affixed sensors and antennas for reading and measuring rate of cure along with drone assisted concrete curing and chemical application machine sprayer. This technology enables an engineered application of liquid-based materials and surface treatments, such as moisture, curing aids, and other chemicals from the placement of fresh concrete through the entire curing process and beyond, at the designed time and rate to ensuring specific objectives such as strength and durability of the concrete surface.

Rate of application, coverage data, and guidance may be directed by analysis of collected data for precise application of moisture, a curing aid, and/or another chemical based in part on the computed evaluation index (EI). The EI serves as an assessment of the curing quality of the surface concrete based on rate of moisture evaporation, porosity, and rate of hydration of the surface concrete to trigger the application of chemicals such as finishing aids, cutting aids, hardeners/densifiers, silanes, or other protective surface applied treatments. The integrated platform of non-contact sensing, collecting, and applying curing and chemical applications may also be coordinated with other autonomous units, such as self-driven power-trowels, saw cutting machines and/or other devices, as well as with manually operated units, such as power-trowels, saw cutting machines, and/or other devices.

The drones may be used for mapping, recording, collecting, and sensing data to assist in operational steps to limit “over-curing” and/or “random cracking” of the concrete. The drones and/or the central control unit may optimize application of moisture, curing aids, and/or other chemicals (e.g., finishing aids, cutting aids, hardeners/densifiers, silanes, protective treatments, etc.).

In addition, the collected data can help in the determination of timing of critical operations such saw-cutting, pavement texturing, power-trowel operations, duration, and track coverage, including blade changes or use of transition blades to determine what areas need additional finishing or prevent over curing, trowel burns, etc. Various autonomous drone assisted drives are tethered (“connected”) wirelessly, enabling system communication and guidance to prevent collision as multiple devices/machinery that is integrated and running simultaneously requiring coordinated synchronization during the placing, curing, and finishing of concrete due to the environment, that is, the wind, temperature, humidity, and dust that can have a significant impact on concrete materials in real-time. Examples may include a sound warning system default when one component undesirably comes within a predetermined distance of another component and system guidance to avoid collision as multiple devices may be collecting data, applying moisture, curing aids, and/or other chemicals, finishing the concrete, and/or cutting the concrete simultaneously.

Artificial intelligence (AI) assisted computations based on collected data may be used to engineer curing efficiencies with precisely calculated methods of curing and finishing or protecting concrete with automated contactless devices and/or machinery for saw cutting joints traverse and longitudinal, texturing to applying correct rates of moisture (e.g., by fogging, misting, spraying, etc.), curing aids, and/or other chemicals with greater responsiveness with respect to the application of chemicals, finishing aids, cutting aids, hardeners/densifiers, silane, and other protective treatments. For floor slabs, finishing the slab requires optimal timing to prevent the slab from getting away from the contractor's control—as to when to saw cut joints, apply chemical treatments or curing compounds. Operations that are planned and coordinated so that construction proceeds with minimal loss of time and effort.

The apparatuses, systems, and methods of this disclosure can be used in any type of concrete paving whether on formed or slip-formed construction. This technology can be applicable to pavement, parking lots, parking decks, bridges, and in the construction and placement of floor slabs. The technology could also be used for smaller jobs and mounted to either robotic equipment or paving equipment in odd-sized concrete pours and parking lot areas.

Use of the apparatuses, systems, and methods of this disclosure may control cracking of curing concrete, which may be achieved by enhancing responsiveness of the process to effectively manage the timing of curing to affect the development of cracking at saw cut joint locations. Thus, the apparatuses, systems, and methods of this disclosure may improve the effectiveness of curing and saw-cutting operations to lower construction cost and extend the service life of concrete pavements by managing these operations relative to the climatic and seasonal conditions prevalent at the time the paving work is being done.

Although the preceding disclosure provides many specifics, these should not be construed as limiting the scope of any of the claims that follow, but merely as providing illustrations of some embodiments of elements and features of the disclosed subject matter. Other embodiments of the disclosed subject matter may be devised which do not depart from the spirit or scope of any of the claims. Features from different embodiments may be employed in combination. Accordingly, the scope of each claim is limited only by its plain language and the legal equivalents thereto.

What is claimed:

1. An autonomous system for managing curing of concrete, comprising:
at least one source of moisture, a curing aid, and/or another chemical in proximity to the concrete;
at least one application drone positionable over different locations of the concrete without contacting the concrete; and
at least one conduit including a first end in communication with the at least one source and a second end carried by the at least one application drone.

2. The autonomous system of claim 1, wherein the at least one application drone selectively applies the moisture, the curing aid, and/or the other chemical to an area of a surface of the concrete based on a moisture content of the concrete.

3. The autonomous system of claim 1, further comprising:
at least one support drone positionable over different locations of the concrete without contacting the concrete to carry and prevent the at least one conduit from contacting the concrete.

4. The autonomous system of claim 1, further comprising:
at least one sensing drone positionable over different locations of the concrete without contacting the concrete.

5. The autonomous system of claim 4, wherein the at least one sensing drone employs ground penetrating radar to determine the moisture content of the concrete at the different locations.

6. The autonomous system of claim 4, wherein the at least one sensing drone includes a processor that, based upon the moisture content of a particular location of the concrete, causes the at least one application drone to apply the moisture, the curing aid, or the other chemical from the at least one source to an area of the concrete around the particular location.

7. The autonomous system of claim 1, further comprising:
a plurality of sensors at different locations of the concrete.

8. The autonomous system of claim 7, wherein the plurality of sensors comprise a plurality of dielectric probes used to determine a dielectric constant and a water content of the concrete at the different locations.

9. The autonomous system of claim 7, further comprising:
a central control unit that communicates with:
the plurality of sensors to receive data therefrom; and
the at least one application drone to control a location of the at least one application drone over the concrete and an operation performed by the at least one application drone while over the concrete.

10. The autonomous system of claim 1, comprising a plurality of sources of the moisture, the curing aid, and/or the other chemical.

11. The autonomous system of claim 10, wherein the at least one conduit selectively communicates with the plurality of sources.

12. A method for curing concrete, comprising:
monitoring a condition of the concrete at different locations;
deploying an application drone above a particular location of the different locations based on the monitoring; and
with the application drone, applying moisture, a curing aid, or another chemical to the particular location based on the monitoring.

13. The method of claim 12, wherein monitoring the condition comprises monitoring a water content and/or a humidity of the concrete at the different locations.

14. The method of claim 12, wherein monitoring the condition comprises monitoring a strain of the concrete at the different locations.

15. The method of claim 12, wherein monitoring the condition of the concrete comprises monitoring the condition of the concrete with a sensing drone.

16. The method of claim 15, wherein monitoring the condition of the concrete with the sensing drone comprises monitoring the condition of the concrete with ground penetrating radar carried by the sensing drone.

17. The method of claim 15, wherein monitoring the condition of the concrete with the sensing drone comprises monitoring the condition of the concrete while the concrete remains in a plastic state.

18. The method of claim 12, wherein monitoring the condition of the concrete comprises monitoring the condition of the concrete with a plurality of sensors at different locations in a surface of the concrete.

19. The method of claim 12, wherein deploying the application drone comprises deploying the application drone to a location within about 18 inches above a surface of the concrete.

20. The method of claim 12, further comprising:
deploying a support drone to carry a conduit extending between a source of the moisture, the curing aid, or the other chemical and the application drone.
